(19) United States
(12) Patent Application Publication
(10) Pub. No.: US 2008/0155632 A1
(43) Pub. Date: Jun. 26, 2008

(54) METHOD OF INTERACTIVE COMMUNICATION BETWEEN COMMUNICATION TERMINALS, SERVER AND INTERACTIVE TELEVISION NETWORK

(75) Inventors: Emmanuel Marilly, Saint-Michel-Sur-Orge (FR); Gerard Delegue, Cachan (FR); Olivier Martinot, Draveil (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/960,691

(22) Filed: Dec. 19, 2007

(30) Foreign Application Priority Data
Dec. 21, 2006 (FR) 0655785

(51) Int. Cl. H04N 7/173

(52) U.S. Cl. 725/114; 725/105; 725/62

(57) ABSTRACT

A method of interactive communication between communication terminals comprises a step of definition of the characteristics of persons with whom a session initiator wishes to have interactive communication, the set of these persons forming a virtual community with this initiator; a step of definition, for the interactive communication session, of the initial media for interaction between the session initiator and the other members of the virtual community; a step of the session initiator sending a request for connection to the terminals of the other members of the virtual community; and a step of definition of the rules for adaptation of the communication media as a function of the context specific to at least one of the members of the community, in particular the session initiator.

### CROSS-REFERENCE TO RELATED APPLICATIONS

This application is based on French Patent Application No. 0655785 filed Dec. 21, 2006, the disclosure of which is hereby incorporated by reference thereto in its entirety, and the priority of which is hereby claimed under 35 U.S.C. §119.

### BACKGROUND OF THE INVENTION

1. Field of the Invention

The technical field of the invention is that of interactive television.

2. Description of the Prior Art

The term “interactive” is difficult to define, because it is applied to many products that are evolving quickly.

For exchanges between humans, the term “interactive” is employed when the participants influence each other through their dialog.

For man/machine exchanges, the term “interactive” is employed for operating conditions enabling reciprocal action in dialog mode or in real time. For example, a machine receives information from a user and responds to the user. For e-learning, the learner intervenes during his learning process and, through this intervention, modifies the learning process.

Interactive television provides a back channel enabling the viewer to send the content provider information or enquiries. This complements the conventional televised content: access to links to Internet sites, T-commerce, video on demand, electronic program guide.

In this way the television becomes a mass market digital electronic device.

The back channel can be apparent on the screen of the television (for example a split screen (separate screen)), the user communicating by means of his remote control and his set top box or a built-in device, for example an IST (Integrated Smart Television) device.

The expression “interactive television” is employed to designate realities that are somewhat different.

Thus the expression “interactive television” has been used to indicate that a television viewer can make a choice between different contents of a digital bundle using an electronic program guide (EPG).

The expression “interactive television” has also been used to designate access to the Internet from an ad hoc set top box (WebTv).

The reality of the services offered under the label “interactive television” can be seen from two angles: the content of the services, on the one hand, and the type of interactivity, on the other hand.

With regard to the service content, a distinction can be made between:
enhanced TV;
call TV;
stand-alone interactive television.

For enhanced television, services are offered that complement the broadcast program. Additional information is sent to the viewer, for example during the vertical blanking interval of the TV signal and/or via telephone lines. This additional information can consist of text, graphics and fixed images concerning the program, web content activated by triggers, new audio and video, or a personalized view (camera angle). For example, the Equidia channel offers subscribers who have a digital terminal connected to a telephone line the facility to open an account and bet at home on all broadcast horse races. The information delivered can be linked to the program being broadcast or not. Enhanced television does not enable communication between persons watching the same program.

Where call TV is concerned, a communication service enables a TV viewer to intervene live or off-line in the content of a broadcast program. For example, the company Tatamia Solutions offers a platform called Tatamia Interactive Channel enabling the broadcasting of SMS (Short Message Service) text messages live on screen. For example, the television viewer can choose a video clip to be transmitted during a broadcast and dedicate it while chatting with their friends. Viewers can also vote or participate in a competition, for example during reality TV broadcasts.

A stand-alone interactive television service does not include any main or accessory television service. These are in particular transactional services such as home banking and classified advertisements. The television receiver can also be used as a receiver terminal for messages exchanged between subscribers, for example (the TV mail service of the company TPS, for example): when a subscriber receives a new message, he is automatically alerted at the bottom of the screen when he changes channel. The television receiver can also be used as a screen for interactive gains offered by a virtual channel.

A distinction is made between a simulated type of interactivity, a remote type of interactivity, and a real type of interactivity.

When interactivity is of the simulated type, the applications and data are integrated into the broadcast video stream, once only or in a loop. The services are made available either in real time when selected by the television viewer or by storage on the hard disc, enabling local interactivity.

When interactivity is of the remote type, there is an exchange of data between the broadcaster and the television viewer by means of an equipment independent of the content broadcasting network. For example, a gambler can access his account via the telephone line to which the set top box is connected.

Real interactivity refers to service broadcast networks that integrate a permanent back channel.

One attraction of interactivity is strengthening the links between distant persons, so as to create virtual communities (for example groups of friends, members of a family, persons sharing the same interests).

The life of these virtual communities would be facilitated by instant communication means offering high performance.

In this line of thinking, there are known, for example, instant messaging services such as Windows Live Messenger, Yahoo!Messenger, Google Talk, ICQ, Livecom, AOL Instant Messenger. These proprietary programs have been developed for fixed computers or certain mobile terminals (Personal Digital Assistants (PDA)) and are generally not mutually compatible.

There have also been initiatives in mobile instant messaging (Mobile Instant Messaging and Presence Services (IMPS)), without so far leading to interoperable services, which would replace SMS (Short Message Service) and MMS (Multimedia Message Service) messages with instant messaging for intelligent portable communication terminals (smartphones).

The Applicant has developed an interactive television technology known as AmigoTV enabling the user to share opinions and emotions among a community. If several friends are watching the same television program, using AmigoTV they can comment live to each other, their voices passing over the Internet, and six persons being able to communicate at the same time. To find out who is watching television and the channel he is watching, it suffices to use the remote control to consult a menu in which all this information is displayed in real time, the presence of the members of the community being indicated by on-screen avatars. AmigoTV also enables images and sounds chosen from a catalog to be sent to illustrate a mood in reaction to a televised event. AmigoTV does not necessitate the use of a keyboard or a mouse. The AmigoTV technology does necessitate a headset, microphone, television and set top box, however.

The invention aims to offer members of a community interactive communication services in a mobile television environment, those services enabling exchanges between persons who are “close”.

Here “close” means at least one of the following:
the persons are geographically close to each other;
the persons are pursuing substantially the same activity when they decide to communicate with each other;
the persons have substantially the same interests;
the persons have access to comparable or compatible telecommunication means.

The interactive communication means according to the invention must enable the members of a community to exchange instant messages, but also to chat, and to exchange voice or video data associated with the television programs broadcast to their mobile terminals.

The communication services offered by the invention must enable the members of a community to exchange emoticons and converse.

### SUMMARY OF THE INVENTION

To this end, a first aspect of the invention relates to a method of interactive communication between communication terminals, the method comprising:
a step of definition of the characteristics of persons with whom a session initiator wishes to have interactive communication, the set of these persons forming a virtual community with this initiator;
a step of definition, for the interactive communication session, of the initial media for interaction between the session initiator and the other members of the virtual community;
a step of the session initiator sending a request for connection to the terminals of the other members of the virtual community,
   this method comprising a step of definition of the rules for adaptation of the communication media as a function of the context specific to at least one of the members of the community, in particular the session initiator.

The method advantageously comprises, during the interactive communication session, the display of television programs on at least one of the communication terminals of the virtual community, in particular the communication terminal of the session initiator. It is nevertheless to be understood that the session initiator may wish to open an interaction session without having to be viewing a television transmission beforehand. For example, a person could announce that he wishes to participate in an interactive communication session during a future transmission, and the members of the community could discuss the modalities of that session (times, communication media chosen, for example).

The definition of the characteristics of the persons between whom interactive communication is provided advantageously takes account of the location of the persons, in particular their geographical location. A virtual community can therefore be defined as a function of the place at which its members are located, or their common destination, for example.

The definition of the characteristics of the persons between whom interactive communication is provided advantageously takes account of the profile of the persons, in particular their interests and the type of relations with the initiator. Among his relationships, the session initiator could, for example, select those who might be interested in a televised program the broadcasting of which has been notified or is in progress.

The definition of the characteristics of the persons between whom interactive communication is provided advantageously takes account of the capacities of the communication terminals used by those persons.

A second aspect of the invention relates to an interactive communication server for implementation of the method as described hereinabove, that server comprising an adaptation rule module containing the service adaptation rules, those rules being either predefined or created by the operator or the session initiator, the server further comprising an engine responsible for configuring, managing and adapting the interactive communication service as a function of the context specific to at least one of the members of the virtual community, in particular the session initiator.

The server advantageously further comprises a media converter module responsible for the consistency of the media chosen by each of the members of the virtual community for their interactive communications.

The server advantageously further comprises a user in the community profile module containing the generic rules of the community based on the profile of the session initiator.

The server advantageously further comprises a proximity community module containing a list of the persons who are in the vicinity of the session initiator.

The server advantageously further comprises a list of friends module containing a list of the friends of the session initiator.

A third aspect of the invention relates to an interactive communication network comprising at least one server as described hereinabove in which at least one of the communication terminals, in particular the communication terminal of the session initiator, is a mobile telecommunication terminal.

### BRIEF DESCRIPTION OF THE DRAWINGS

Other objects and advantages of the invention will become apparent in the light of the description given hereinafter with reference to the appended drawings, in which:

FIG. 1 is a diagrammatic overview of the means of one embodiment of the invention;

FIG. 2 is a more detailed diagram of some of the means used in the invention.

### DETAILED DESCRIPTION OF THE PREFERRED EMBODIMENT

The invention provides an interactive communication service for a community in a mobile television environment.

This service is referred to hereinafter as a mobile smart chat TV service (MSCTV service). As will become apparent hereinafter, in the context of the invention, the term “chat” as used in instant messaging refers not only to exchange of text messages but also exchange of sounds, images, videos or files.

The MSCTV service enables discussion between members of a community by means of text, voice or video, as well as the exchange of emoticons, emotional states and intellectual attitudes (moods), when the members of that community (for example friends) are watching the same television program on their mobile terminal, or using the same interactive mobile application.

These exchanges are integrated into the screen of the mobile terminal and the MSCTV service can use the interfaces of the mobile terminal (for example microphone, camera, keypad).

The MSCTV service takes account of the context, the location, and the profile of the user and those of the members of the community.

Here “context” refers in particular to:
the environment in which the members of the community are located (for example private place, public place, noisy or quiet surroundings),
the type of network (bandwidth, quality of service);
the capabilities of the communication terminals of the community members (screen size, media supported, terminal type),
the context in which the interactive communication session takes place (activities of community members, events),
the social context (should community members be listed as friends, neutral parties, enemies, neighbors, work colleagues or relations);
the personal context (mood of the community members, aggressiveness, stress),
the selected television program.

The term “location” refers not only to the geographical location but also to other parameters relating to movement: destination, speed.

Here “user profile” refers in particular to the description of the user, their preferences, their rights, and historical data.

The effect of the environment on the MSCTV service can be illustrated in the following manner: a community member begins his exchanges with the other members of the community in voice mode and switches to text mode when he enters a public place or noisy surroundings. For example, Bob is alone in a train compartment and is using the MSCTV service to watch a football match on his mobile terminal. Being on his own in the compartment, Bob conducts a discussion with his friends in voice mode. When someone enters and sits down in the compartment, Bob decides to continue the conversation with his friends without annoying that person. Bob decides to switch from voice mode to text mode. As a function of specific conditions, the passage from voice mode to text mode can be automatic, for example changing from text mode to voice mode if a community member has to drive a vehicle during an exchange session.

The effect of the terminals on the MSCTV service can be illustrated in the following manner. During an MSCTV session, one community member A is using a media different from that chosen by the other members B, C, D to interact. For example, this user A is using voice mode while the other community members B, C, D are using text mode to communicate. Voice synthesis enables the other community members B, C, D to communicate with the user A, while a voice recognition device enables the user A to communicate with the other community members B, C, D.

The MSCTV service can be deployed over existing elements of the mobile network.

Several standards currently cover broadcasting television to mobile terminals: MPEG-4 BIFS, MPEG-LASeR (Lightweight Application Scene Representation, promoted by Streamezzo), SVG (Scalable Vector Graphics, promoted by the World Wide Web Consortium (W3C)), MORE (Mobile Open Rich-Media Environment, promoted by Nokia). For television broadcasting to mobile terminals such as UMTS (Universal Mobile Telecommunications System) telephones, a cell supports a small number of simultaneous high bit rate (typically 256 kbit/s) multimedia sessions. This capacity will doubtless be enhanced by the introduction of HSDPA (High Speed Downlink Packet Access) or 3GLTE (3GPP Long Term Evolution). The “broadcast” solution is not subject to this limitation, three technologies for broadcasting television to mobile terminals being possible:
MBMS (Multimedia Broadcast/Multicast Service), an extension of the UMTS;
terrestrial digital networks such as DVB-H (Digital Video Broadcast transmission to Handheld terminals), T-DMB (Terrestrial Digital Multimedia Broadcasting), Media-Flo (Media Forward Link Only), and the Japanese ISDB-T network;
hybrid satellite/terrestrial networks such as S-DMB in Korea, MobaHO! in Japan or DVB-H adapted to the S band as developed by the Applicant, providing a capacity of 5 to 11 Mbit/s (8 MHz), and 20 to 30 channels, compared to the three 256 kbit/s channels of MBMS.

The MSCTV service can be deployed via the broadcast channel employing DVB-H, for example, the back channel using the 3G network.

In another embodiment, the MSCTV service is integrated into an IMS (IP Multimedia Subsystem) environment. Integration into an IMS solution offers all the advantages offered by an IMS environment such as AAC, GLMS (Group List Management Server), HSS (Home Subscriber Server, for example user profile), communications (unified messaging, voice and video mail, voice and video portal, conference calls).

Deployment on fixed or fixed/mobile networks can also be envisaged.

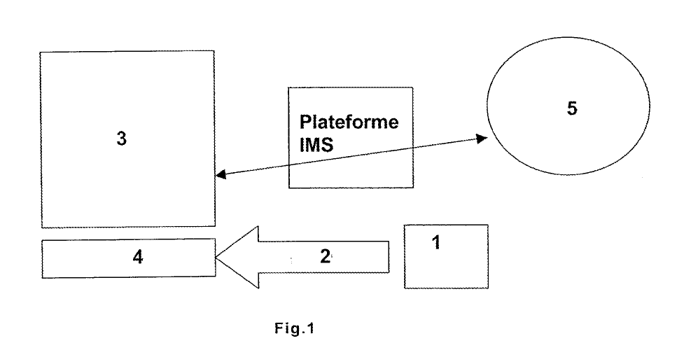

FIG. 1 shows implementation of an MSCTV service in an IMS environment.

A television program 1 is broadcast using the network 2, for example a DVB-H network.

The end user 3 decides to have a discussion by means of the MSCTV service with a community (friends, persons located in the same geographical area, persons having the same profile).

The end user 3 chooses a predefined rule or defines his rules himself for the selection of the members of the community.

Using his terminal 4, the end user 3 contacts a server 5 for application of these predefined rules or to institute his own rules.

For example, the end user 3 chooses the “discussion with persons nearby” option. The end user then receives a list of persons who are located nearby and can choose those with whom he does not wish to interact.

The end user can also choose automatic rules to be applied if the context changes: for example, to switch from voice mode to text mode on entering a public place.

When the configuration of the session has been established, the MSCTV service is operational and interaction can begin. The service will be adapted throughout the session.

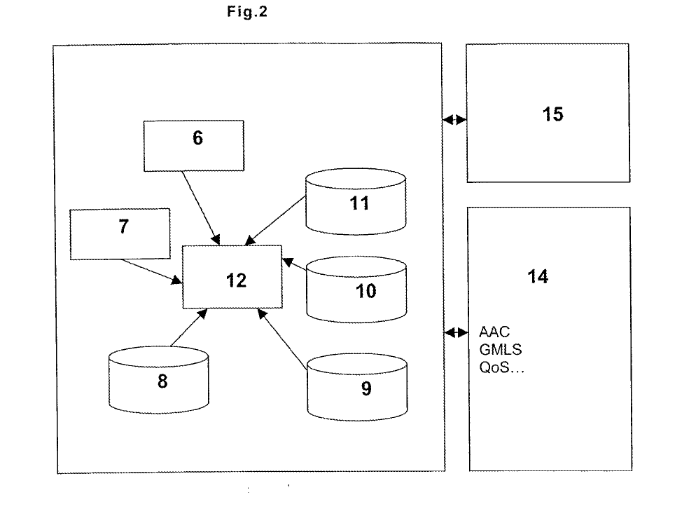

FIG. 2 is a diagram of the MSCTV server.

That server comprises a plurality of modules.

The adaptation rule module 6 contains service adaptation rules that are either predefined or created by the operator or the end user.

The media converter module 7 is responsible for the consistency of media between the members of the community. For example, if some community members are using voice mode when others are using text mode, the media converter module 7 will ensure that all members of the community can interact with each other. For example, this module 7 will be responsible for converting text data into voice data (for example by voice synthesis) or voice data into text data (speech recognition).

The community rule module 8 contains rules specific to the community. Those rules are defined by the operator or the end user.

The user profile in the community module 9 contains generic rules of the community based on the user profile. It supplies lists of persons who have a profile close to or similar to that of the end user.

The proximity community module 10 contains a list of the persons who are in the vicinity of the end user. Different rules can be defined by the end user or the operator. Basic rules concern the proximity (for example perimeter) or more contextual rules can be defined (persons on the same train, the same bus).

The list of friends module 11 contains a list of the friends of the end user. This list is created by the end user.

The engine 12 of the MSCTV service is responsible for configuring, managing and adapting the MSCTV service. This engine manages the various modules 6-11 constituting the MSCTV service.

The MSCTV service server 13 is interfaced with enablers 14 of the IMS environment such as presence, GLMS, AAC, QoS.

The server 13 is also interfaced with communication applications 15.

The use of the MSCTV service will now be described.

John is watching a football match on his mobile terminal. He decides to converse with his friends using the MSCTV service. He launches the MSCTV application. Numerous options are offered to him. John can communicate with his friends (or a selection of them), for example persons situated in the same place (for example on the same train, the same bus). John can also select persons having the same profile as himself (or a profile close to his profile). John can also select persons having a particular profile.

John chooses to have a conversation by means of the MSCTV service with his friends who are watching the same television program. The conversation using the MSCTV service can be conducted by exchanging text, voice, video or interactive images/sounds/icons. John chooses to have a video conversation.

Discussions between community members and comments are then possible during the football match. Icons and animations can be exchanged and appear on the television screens of the friends so as to describe their respective moods and emotions.

One example of a scenario for use of the MSCTV service is as follows.

In a first step, Bart decides to watch a football match on his mobile terminal. He then chooses to activate the MSCTV service to have a discussion with other persons. Bart then accesses the service guide. Several options are offered in that guide, for example: program guide, voting, chat.

In a second step, Bart chooses the chat option.

In a third step, Bart configures the MSCTV service session. He is offered the following criteria: filtering of persons forming the community (friends, proximity, profiles), selection of media, session adaptation rules. Bart defines the criteria of the community, selects the media used to interact, and the adaptation rules.

In a fourth step, the MSCTV service is then functional. Bart can see the persons connected (for example through icons, photographs). In addition to video images, Bart can send texts and icons to his friends.

Alternatively, Bart uses a mobile communication terminal comprising a video camera and chooses to interact with his friends using voice and video. If Bart enters a public place, thanks to the adaptation rules, he is automatically switched from the voice mode to the text mode and his words appear on the screens of the other members of the community, in a window or overlaid on the screen display.

The interactive communication service according to the invention has numerous advantages:
management of the community integrating the context;
adaptation of the service to the context (for example varied environments), to the performance of the networks and the terminals, and to the media used (text, voice, video);
offer of new services for mobile television.

With the MSCTV service, the members of the same community who are watching the same television program can interact via varied media and applications. A community can be created on the basis of varied criteria: persons having the same profiles and interests, for example, geographical proximity. The criteria for creating a community can be chosen by an end user or an operator. The MSCTV service can be integrated into a community management module or interfaced to such a module.

1. A method of interactive communication between communication terminals, the method comprising:
a step of definition of the characteristics of persons with whom a session initiator wishes to have interactive communication, the set of these persons forming a virtual community with this initiator;
a step of definition, for the interactive communication session, of the initial media for interaction between the session initiator and the other members of the virtual community;
a step of the session initiator sending a request for connection to the terminals of the other members of the virtual community,
a step of definition of the rules for adaptation of the communication media as a function of the context specific to at least one of the members of the community, in particular the session initiator.

2. An interactive communication method according to claim 1, comprising, during the interactive communication session, the display of television programs on at least one of the communication terminals of the virtual community, in particular the communication terminal of the session initiator.

3. An interactive communication method according to claim 1, wherein the definition of the characteristics of the persons between whom interactive communication is provided takes account of the location of the persons, in particular their geographical location.

4. An interactive communication method according to claim 1, wherein the definition of the characteristics of the persons between whom interactive communication is provided takes account of the profile of the persons, in particular their interests and the type of relations with the initiator.

5. An interactive communication method according to claim 1, wherein the definition of the characteristics of the persons between whom interactive communication is provided takes account of the capacities of the communication terminals used by those persons.

6. An interactive communication server for implementation of the method according to claim 1, that server comprising an adaptation rule module containing the service adaptation rules, those rules being either predefined or created by the operator or the session initiator, the server further comprising an engine responsible for configuring, managing and adapting the interactive communication service as a function of the context specific to at least one of the members of the virtual community, in particular the session initiator.

7. A server according to claim 6, further comprising a media converter module responsible for the consistency of the media chosen by each of the members of the virtual community for their interactive communications.

8. A server according to claim 6, further comprising a user in the community profile module containing the generic rules of the community based on the profile of the session initiator.

9. A server according to claim 6, further comprising a proximity community module containing a list of the persons who are in the vicinity of the session initiator.

10. A server according to claim 6, further comprising a list of friends module containing a list of the friends of the session initiator.

11. An interactive communication network comprising at least one server according to claim 6, wherein at least one of the communication terminals, in particular the communication terminal of the session initiator, is a mobile telecommunication terminal.
